(19) United States
(12) Patent Application Publication
(10) Pub. No.: US 2017/0185675 A1
(43) Pub. Date: Jun. 29, 2017

(54) FINGERPRINTING AND MATCHING OF CONTENT OF A MULTI-MEDIA FILE

(71) Applicant: Telefonaktiebolaget LM Ericsson (publ), Stockholm (SE)

(72) Inventor: Tommy ARNGREN, SÖDRA SUNDERBYN (SE)

(73) Assignee: Telefonaktiebolaget LM Ericsson (publ), Stockholm (SE)

(21) Appl. No.: 15/312,848

(22) PCT Filed: May 27, 2014
(86) PCT No.: PCT/SE2014/050655

§ 371 Date: Nov. 21, 2016

(51) Int. Cl. G06F 17/30; G10L 19/018; G06K 9/62; G06F 21/10; G06K 9/00

(52) U.S. Cl. CPC G06F 17/30784; G06F 17/30743; G06F 21/10; G06K 9/00744; G06K 9/6201; G10L 19/018

(57) ABSTRACT

There is provided a method for fingerprinting and matching of content of a multi-media file. The method comprises extracting (S1) fingerprints from at least a portion of the multi-media file in the form of content features detected in at least two different modalities, each content feature detected in a respective modality, and building (S2) a multi-vector fingerprint pattern representing the multi-media file by representing the content features in at least one feature vector per modality. The method also comprises comparing (S3) the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

### TECHNICAL FIELD

The proposed technology generally relates to a method for fingerprinting and matching of content of a multi-media file, and a method for enabling matching of content of a multi-media file, as well as a corresponding system, server, communication device, computer program and computer program product.

### BACKGROUND

The use of digital technology and network communications such as the Internet and information sharing models like the World Wide Web is growing bigger and bigger by every day. We are also using the Internet more often on a daily basis on a variety of different devices such as Personal Computers, PCs, Phones, Tablets and IP-TV.

It is expected that over two-thirds of the world's mobile data traffic will be video by 2018. Mobile video will increase 14-fold between 2013 and 2018, accounting for over 69 percent of total mobile data traffic by the end of the forecast period, as outlined in reference [1].

The sum of all forms of video including TV, Video on Demand, VoD, Internet, and Peer-to-Peer, P2P, will be in the range of 80 to 90 percent of global consumer traffic by 2017, as outlined in reference [2].

Today, every minute 60 hours of video is uploaded on the content sharing website YouTube. That means one hour of video per second. According to the video sharing website YouTube, every day 100 years of video content is searched using content identification [3].

Set against this background, content producers and providers are continually looking for ways to control access, e.g. through Digital Rights Management, DRM, to their premium and valuable content and to prevent illegal distribution on the internet. Also, content sharing sites like YouTube have their own solution, Content ID, to solve issues surrounding copyright infringement and Content ID is also a source for revenues for both YouTube and copyright holders.

There are two technologies, watermarking and fingerprinting, which are used for automatically tracking and protecting content.

Watermarking embed information, hidden data, within a video and/or audio signal. The watermark can be seen as a filter applied to an uncompressed video file. The filter is programmed with the data to be embedded and the “key” that enables the data to be hidden.

Fingerprinting refers to the process of extracting fingerprints, unique characteristics, from content and compared to watermarking it does not add or alter video content. Fingerprinting is also known as “robust hashing”, “perceptual hashing”, “content-based copy detection, CBCD” in the research literature. Different types of signatures are used or combined to form a video fingerprint, including spatial, temporal, color and transform-domain signatures.

This technology makes it possible to analyze media and to identify unique characteristics, fingerprints, which can be compared with fingerprints stored in a database, e.g. the mobile application Shazam [4].

Content providers like YouTube have systems that can scan files and match their fingerprints against a database of copyrighted material and stop users from uploading copyrighted files. The system, which became known as Content ID, creates an ID file for copyrighted audio and video material, and stores it in a database. When a video is uploaded, it is checked against the database, and flags the video as a copyright violation if a match is found.

Problems with watermarking is that the inserted marks can be destroyed or distorted when the format of the video is transformed or during transmission. Watermarking systems and techniques are not generic or standardized and a watermark generated by one technology can normally not be read by a system using a different technology. And even when two systems use the exact same technology, one customer would not be able to read another's watermarks without the secret key that reveals where to find the watermark and how to decode it.

The challenge with fingerprinting systems is to be resilient to situations where the content such as an image or frame is significantly altered, for instance adding a logo, re-encoding the content with a much lower quality compression scheme, cropping, and so forth.

It's usually easier to identify music, because music still has to sound basically the same to the end user, and there is less data to process.

Existing methods for fingerprinting and matching typically rely on advanced mathematical analysis and processing such as transform-domain analysis, which is time-consuming and requires a lot of processing power.

Reference [5] relates to multi-modal detection of video copies. The method first extracts independent audio and video fingerprints representing changes in the content. The cross-correlation with phase transform is computed between all signature pairs and accumulated to form a fused cross-correlation signal. In the full-query algorithm, the best alignment candidates are retrieved and a normalized scalar product is used to obtain a final matching score. In the partial query, a histogram is created with optimum alignments for each sub-segment and only the best ones are considered and further processed as in the full-query. A threshold is used to determine whether a copy exists.

Reference [6] relates to a computer-implemented method, apparatus, and computer program product code for temporal, event-based video fingerprinting. In one embodiment, events in video content are detected. The video content comprises a plurality of video frames. An event represents discrete points of interest in the video content. A set of temporal, event-based segments are generated using the events.

Each temporal, event-based segment is a segment of the video content covering a set of events. A time series signal is derived from each temporal, event-based segment using temporal tracking of content-based features of a set of frames associated with the each temporal, event-based segment. A temporal segment based fingerprint is extracted based on the time series signal for the each temporal, event-based segment to form a set of temporal segment based fingerprints associated with the video content.

Reference [7] relates to a method for use in identifying a segment of audio and/or video information and comprises obtaining a query fingerprint at each of a plurality of spaced-apart time locations in said segment, searching fingerprints in a database for a potential match for each such query fingerprint, obtaining a confidence level of a potential match to a found fingerprint in the database for each such query fingerprint, and combining the results of searching for potential matches, wherein each potential match result is weighted by a respective confidence level.

Reference [8] relates to a method for comparing multimedia content to other multimedia content via a content analysis server. The technology includes a system and/or a method of comparing video sequences. The comparison includes receiving a first list of descriptors pertaining to a plurality of first video frames and a second list of descriptors pertaining to a plurality of second video frames; designating first segments of the plurality of first video frames that are similar and second segments of the plurality of second video frames that are similar; comparing the first segments and the second segments; and analyzing the pairs of first and second segments to compare the first and second segments to a threshold value.

Reference [9] relates to content based copy detection in which coarse representation of fundamental audio-visual features are employed.

### SUMMARY

It is a general object to find a new and improved way to perform fingerprinting and matching of content of a multi-media file.

In particular it is desirable to enable faster and/or more robust fingerprinting and matching.

It is a specific object to provide a method for fingerprinting and matching of content of a multi-media file.

It is another specific object to provide a method, performed by a server in a communication network, for fingerprinting and matching of content of a multi-media file. It is also an object to provide a corresponding computer program and computer program product.

It is yet another specific object to provide a method, performed by a communication device in a communication network, for enabling matching of content of a multi-media file. It is also an object to provide a corresponding computer program and computer program product.

It is also a specific object to provide a system configured to perform fingerprinting and matching of content of a multi-media file.

It is a specific object to provide a server configured to perform fingerprinting and matching of content of a multi-media file.

It is another specific object to provide a communication device configured to enable matching of content of a multi-media file.

It is yet another specific object to provide a server for fingerprinting and matching of content of a multi-media file.

It is also a specific object to provide a communication device for enabling matching of content of a multi-media file.

These and other objects are met by at least one embodiment of the proposed technology.

According to a first aspect, there is provided a method for fingerprinting and matching of content of a multi-media file. The method comprises the steps of:
extracting fingerprints from at least a portion of the multi-media file in the form of content features detected in at least two different modalities, each content feature detected in a respective modality;
building a multi-vector fingerprint pattern representing the multi-media file by representing the content features in at least one feature vector per modality; and
comparing the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

In this way, by extracting content features in at least two different modalities, building a multi-vector fingerprint pattern and comparing content features in multiple modalities, a faster and/or more robust fingerprinting and matching can be achieved. For example, the similarity level may reach the threshold much faster than traditional matching procedures by using several feature vectors of different modalities in the multi-modality matching analysis.

In an optional embodiment, the method further comprises the step of identifying, if the level of similarity exceeds the threshold, the multi-media content corresponding to the fingerprint pattern(s) in the database for which the level of similarity exceeds the threshold.

In another optional embodiment, the method further comprises the step of adding, if the level of similarity is lower than the threshold, the multi-vector fingerprint pattern to the database together with an associated content identifier.

In yet another optional embodiment, the at least two different modalities relate to different image and/or audio analysis processes for detecting content features including at least one of the following: text or character recognition, face recognition, speech recognition, object detection and color detection.

By way of example, the detected content features include at least textual features or voice features detected based on text recognition or speech recognition. This optional embodiment introduces new and customized modalities that enables fast and effective matching.

In an optional embodiment, the multi-modality matching process is a combined matching process involving at least two modalities.

In another optional embodiment, the level of similarity is determined based on the number of matched content features over a period of time, per modality or for several modalities combined, or
the level of similarity is determined based on the number of consecutive matched content features over a period of time, per modality or for several modalities combined, or
the level of similarity is determined based on a ratio between the number of matched content features and the total number of detected content features over the same period of time, per modality or for several modalities combined.

In yet another optional embodiment, the method for fingerprinting and matching of content is used for multi-media copy detection where a copy detection response is generated if the level of similarity exceeds the threshold, or for multi-media content discovery where a content discovery response is generated if the level of similarity exceeds the threshold.

According to a second aspect, there is provided a method, performed by a server in a communication network, for fingerprinting and matching of content of a multi-media file. The method comprises the steps of:
building a multi-vector fingerprint pattern representing the multi-media file by representing content features, detected from at least a portion of the multi-media file in at least two different modalities, in at least one feature vector per modality, each content feature detected in a respective modality; and
comparing the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

This provides an efficient server-solution for fingerprinting and matching of content of a multi-media file.

In an optional embodiment, the server extracts at least part of the content features as fingerprints from at least a portion of the multi-media file, or the server receives at least part of the content features.

In another optional embodiment, the server identifies, if the level of similarity exceeds the threshold, the multi-media content corresponding to the fingerprint pattern(s) in the database for which the level of similarity exceeds the threshold.

In yet another optional embodiment, the server receives, from a requesting communication device, the multi-media file or content features extracted therefrom, and identifies matching multi-media content, and sends a response including a notification associated with the matching multi-media content to the requesting communication device.

By way of example, the server, for multi-media copy detection, sends a copy detection response to the requesting communication device in connection with the communication device uploading the multi-media file to the server.

According to another example, the server, for multi-media copy detection, receives a copy detection query from the requesting communication device, and sends a corresponding copy detection response to the requesting communication device.

In an optional embodiment, the server may identify a content owner associated with matching multi-media content and send a notification to the content owner in response to multi-media copy detection.

According to another example, the server, for multi-media content discovery, receives a content discovery query from the requesting communication device, and sends a corresponding content discovery response to the requesting communication device.

In an optional embodiment, the at least two different modalities relate to different image and/or audio analysis processes for detecting content features including at least one of the following: text or character recognition, face recognition, speech recognition, object detection and color detection.

According to a third aspect, there is provided a method, performed by a communication device in a communication network, for enabling matching of content of a multi-media file. The method comprises the steps of:
extracting fingerprints from at least a portion of the multi-media file in the form of content features detected in at least two different modalities to provide a basis for at least part of a multi-vector fingerprint pattern in which content features are organized in at least one feature vector per modality, each content feature detected in a respective modality;
sending the detected content features or the detected content features together with at least a portion of the multi-media file to a server to enable the server to build the multi-vector fingerprint pattern and compare the multi-vector fingerprint pattern to fingerprint patterns corresponding to known multi-media content, in a database based on a multi-modality matching analysis; and
receiving a response from the server including a notification associated with the result of the multi-modality matching analysis performed by the server.

This provides a basis for at least part of a multi-vector fingerprint pattern and enables the server with which the communication device is cooperating to build a multi-vector fingerprint pattern that can be compared to fingerprint patterns in a database. In this way, the communication device provides useful support for efficient fingerprinting and matching.

In an optional embodiment, the communication device extracts fingerprints from at least a portion of the multi-media file in the form of content features detected in at least two different modalities, and sends these content features to the server.

In another optional embodiment, the response includes an identification of multi-media content corresponding to the fingerprint pattern(s) in the database for which the level of similarity compared to the multi-vector fingerprint pattern exceeds a threshold.

According to a fourth aspect, there is provided a system configured to perform fingerprinting and matching of content of a multi-media file. The system is configured to extract fingerprints from at least a portion of the multi-media file in the form of content features detected in at least two different modalities, each content feature detected in a respective modality. The system is further configured to build a multi-vector fingerprint pattern representing the multi-media file by representing the content features in at least one feature vector per modality. The system is also configured to compare the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

In an optional embodiment, the system is configured to identify, if the level of similarity exceeds the threshold, the multi-media content corresponding to the fingerprint pattern(s) in the database for which the level of similarity exceeds the threshold.

In another optional embodiment, the system is configured to add, if the level of similarity is lower than the threshold, the multi-vector fingerprint pattern to the database together with an associated content identifier.

In yet another optional embodiment, the at least two different modalities relate to different image and/or audio analysis processes for detecting content features including at least one of the following: text or character recognition, face recognition, speech recognition, object detection and color detection.

By way of example, the system may be configured to extract fingerprints in the form of at least textual features or voice features detected based on text recognition or speech recognition.

In an optional embodiment, the system is configured to determine the level of similarity based on the number of matched content features over a period of time, per modality or for several modalities combined, or
the system is configured to determine the level of similarity based on the number of consecutive matched content features over a period of time, per modality or for several modalities combined, or
the system is configured to determine the level of similarity based on a ratio between the number of matched content features and the total number of detected content features over the same period of time, per modality or for several modalities combined.

In another optional embodiment, the system is configured to perform multi-media copy detection where a copy detection response is generated if the level of similarity exceeds the threshold or configured to perform multi-media content discovery where a content discovery response is generated if the level of similarity exceeds the threshold.

In yet another optional embodiment, the system comprises a processor and a memory. The memory comprises instructions executable by the processor, whereby the processor is operative to perform the fingerprinting and matching of content of the multi-media file.

According to a fifth aspect, there is provided a server configured to perform fingerprinting and matching of content of a multi-media file. The server is configured to build a multi-vector fingerprint pattern representing the multi-media file by representing content features, detected from at least a portion of the multi-media file in at least two different modalities, in at least one feature vector per modality, each content feature detected in a respective modality. The server is further configured to compare the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

In an optional embodiment, the server is configured to extract at least part of the content features as fingerprints from at least a portion of the multi-media file, or the server is configured to receive at least part of the content features.

In another optional embodiment, the server is configured to identify, if the level of similarity exceeds the threshold, the multi-media content corresponding to the fingerprint pattern(s) in the database for which the level of similarity exceeds the threshold.

By way of example, the server may be configured to receive, from a requesting communication device, the multi-media file or content features extracted therefrom. The server may be configured to identify matching multi-media content, and configured to send a response including a notification associated with the matching multi-media content to the requesting communication device.

In an optional embodiment, the server, for multi-media copy detection, is configured to send a copy detection response to the requesting communication device in connection with the communication device uploading the multi-media file to the server.

In another optional embodiment, the server, for multi-media copy detection, is configured to receive a copy detection query from the requesting communication device, and configured to send a corresponding copy detection response to the requesting communication device.

In yet another optional embodiment, the server is configured to identify a content owner associated with matching multi-media content, and configured to send a notification to the content owner in response to multi-media copy detection.

According to another example, the server, for multi-media content discovery, may be configured to receive a content discovery query from the requesting communication device, and the server may be configured to send a corresponding content discovery response to the requesting communication device.

In an optional embodiment, the at least two different modalities relate to different image and/or audio analysis processes for detecting content features including at least one of the following: text or character recognition, face recognition, speech recognition, object detection and color detection.

In an optional embodiment, the server comprises a processor and a memory. The memory comprises instructions executable by the processor, whereby the processor is operative to perform the fingerprinting and matching of content of the multi-media file.

According to a sixth aspect, there is provided a communication device configured to enable matching of content of a multi-media file. The communication device is configured to extract fingerprints from at least a portion of the multi-media file in the form of content features detected in at least two different modalities to provide a basis for at least part of a multi-vector fingerprint pattern in which content features are organized in at least one feature vector per modality, each content feature detected in a respective modality. The communication device is further configured to send the detected content features or the detected content features together with at least a portion of the multi-media file to a server to enable the server to build the multi-vector fingerprint pattern and compare the multi-vector fingerprint pattern to fingerprint patterns corresponding to known multi-media content, in a database based on a multi-modality matching analysis. The communication device is also configured to receive a response from the server including a notification associated with the result of the multi-modality matching analysis performed by the server.

In an optional embodiment, the communication device is configured to extract fingerprints from at least a portion of the multi-media file in the form of content features detected in at least two different modalities, and the communication device is configured to send the extracted content features to the server.

In another optional embodiment, the communication device is configured to receive a response from the server including an identification of multi-media content corresponding to the fingerprint pattern(s) in the database for which the level of similarity compared to the multi-vector fingerprint pattern exceeds a threshold.

In yet another optional embodiment, the communication device comprises a processor and a memory. The memory comprises instructions executable by the processor, whereby the processor is operative to enable the matching of content of a multi-media file.

In an optional embodiment, the communication device may be a network terminal or a computer program running on a network terminal.

According to a seventh aspect, there is provided a computer program comprising instructions, which when executed by at least one processor, cause the at least one processor to:
build a multi-vector fingerprint pattern representing a multi-media file by representing content features, detected from at least a portion of the multi-media file in at least two different modalities, in at least one feature vector per modality, each content feature detected in a respective modality; and
compare the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

According to an eighth aspect, there is provided a computer program comprising instructions, which when executed by at least one processor, cause the at least one processor to:
extract fingerprints from at least a portion of a multi-media file in the form of content features detected in at least two different modalities to provide a basis for at least part of a multi-vector fingerprint pattern in which content features are organized in at least one feature vector per modality, each content feature detected in a respective modality;
prepare the detected content features or the detected content features together with at least a portion of the multi-media file for transfer to a server to enable the server to build the multi-vector fingerprint pattern and compare the multi-vector fingerprint pattern to fingerprint patterns corresponding to known multi-media content, in a database based on a multi-modality matching analysis; and
read a response from the server including a notification associated with the result of the multi-modality matching analysis performed by the server.

According to a ninth aspect, there is provided a computer program product comprising a computer-readable storage having stored thereon a computer program according to the seventh or eighth aspect.

According to a tenth aspect, there is provided a server for fingerprinting and matching of content of a multi-media file. The server comprises:
a pattern building module for building a multi-vector fingerprint pattern representing the multi-media file by representing content features, detected from at least a portion of the multi-media file in at least two different modalities, in at least one feature vector per modality, each content feature detected in a respective modality; and
a pattern comparing module for comparing the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

According to an eleventh aspect, there is provided a communication device for enabling matching of content of a multi-media file. The communication device comprises:
a fingerprint extracting module for extracting fingerprints from at least a portion of the multi-media file in the form of content features detected in at least two different modalities to provide a basis for at least part of a multi-vector fingerprint pattern in which content features are organized in at least one feature vector per modality, each content feature detected in a respective modality;
a preparation module for preparing the detected content features or the detected content features together with at least a portion of the multi-media file for transfer to a server to enable the server to build the multi-vector fingerprint pattern and compare the multi-vector fingerprint pattern to fingerprint patterns corresponding to known multi-media content, in a database based on a multi-modality matching analysis; and
a reading module for reading a response from the server including a notification associated with the result of the multi-modality matching analysis performed by the server.

Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1 is a schematic flow diagram illustrating an example of a method for fingerprinting and matching of content of a multi-media file according to an embodiment.

FIG. 2 is a schematic flow diagram illustrating another example of a method for fingerprinting and matching of content of a multi-media file according to an optional embodiment.

FIG. 3 is a schematic flow diagram illustrating an example of a method, performed by a server in a communication network, for fingerprinting and matching of content of a multi-media file according to an embodiment.

FIG. 4 is a schematic flow diagram illustrating another example of a method, performed by a server in a communication network, for fingerprinting and matching of content of a multi-media file according to an optional embodiment.

FIG. 5 is a schematic diagram illustrating an example of signaling between a communication device and a server in a communication network according to an optional embodiment.

FIG. 6A is a schematic diagram illustrating an example of signaling involved in copy detection according to an optional embodiment.

FIG. 6B is a schematic diagram illustrating another example of signaling involved in copy detection according to an optional embodiment.

FIG. 7 is a schematic diagram illustrating an example of signaling involved in content discovery/search according to an optional embodiment.

FIG. 8 is a schematic flow diagram illustrating an example of a method, performed by a communication device in a communication network, for enabling matching of content of a multi-media file according to an embodiment.

FIG. 9 is a schematic block diagram illustrating an example of a system configured to perform fingerprinting and matching of content of a multi-media file according to an embodiment.

FIG. 10 is a schematic block diagram illustrating an example of a server configured to perform fingerprinting and matching of content of a multi-media file according to an embodiment.

FIG. 11 is a schematic block diagram illustrating an example of a communication device configured to enable matching of content of a multi-media file according to an embodiment.

FIG. 12 is a schematic block diagram illustrating an example of a server for fingerprinting and matching of content of a multi-media file according to an embodiment.

FIG. 13 is a schematic block diagram illustrating an example of a communication device for enabling matching of content of a multi-media file according to an embodiment.

FIG. 14 is a schematic diagram illustrating an example of a system overview according to an optional embodiment.

FIG. 15A is a schematic diagram illustrating an example of a video image and the extraction of face and text features for a certain time segment of a video file according to an optional embodiment.

FIG. 15B is a schematic diagram illustrating another example of a video image and the extraction of face and text features for a certain time segment of a video file according to an optional embodiment.

FIG. 16 is a schematic diagram illustrating an example of a process overview including extracting and matching fingerprints according to an optional embodiment.

FIG. 17 is a schematic diagram illustrating another example of a process overview including extracting and matching fingerprints according to an optional embodiment.

### DETAILED DESCRIPTION

Throughout the drawings, the same reference designations are used for similar or corresponding elements.

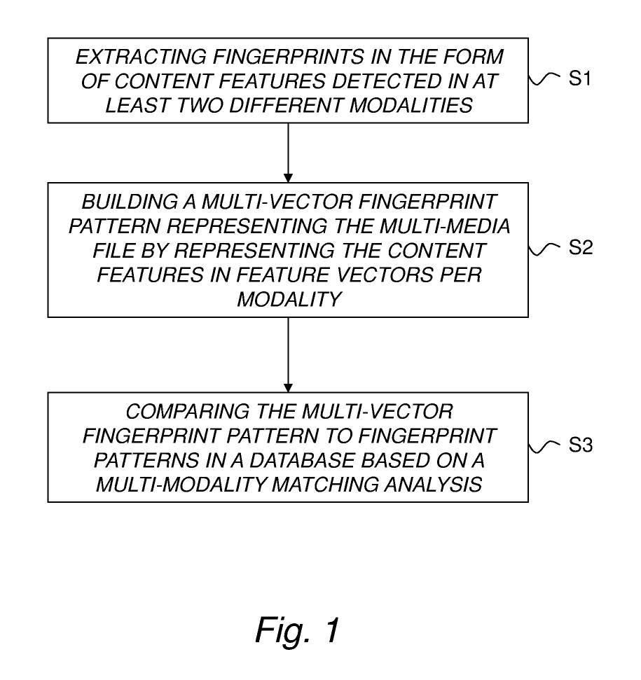

FIG. 1 is a schematic flow diagram illustrating an example of a method for fingerprinting and matching of content of a multi-media file according to an embodiment.

The method comprises the following steps of:

S1: extracting fingerprints from at least a portion of the multi-media file in the form of content features detected in at least two different modalities, each content feature detected in a respective modality;

S2: building a multi-vector fingerprint pattern representing the multi-media file by representing the content features in at least one feature vector per modality; and

S3: comparing the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

As explained, the content features are represented in a multi-vector fingerprint pattern in at least one feature vector per modality. In other words, each modality is associated with at least one feature vector comprising representations of content features detected in that modality. The content features in such a feature vector represent the modality in the multi-media file.

By extracting content features in at least two different modalities, building a multi-vector fingerprint pattern and comparing content features in multiple modalities, a faster and/or more robust fingerprinting and matching can be achieved.

For example, the similarity level may reach the threshold much faster than traditional matching procedures by using several feature vectors of different modalities in the multi-modality matching analysis.

The proposed technology also enables more effective and robust matching of content of a multi-media file.

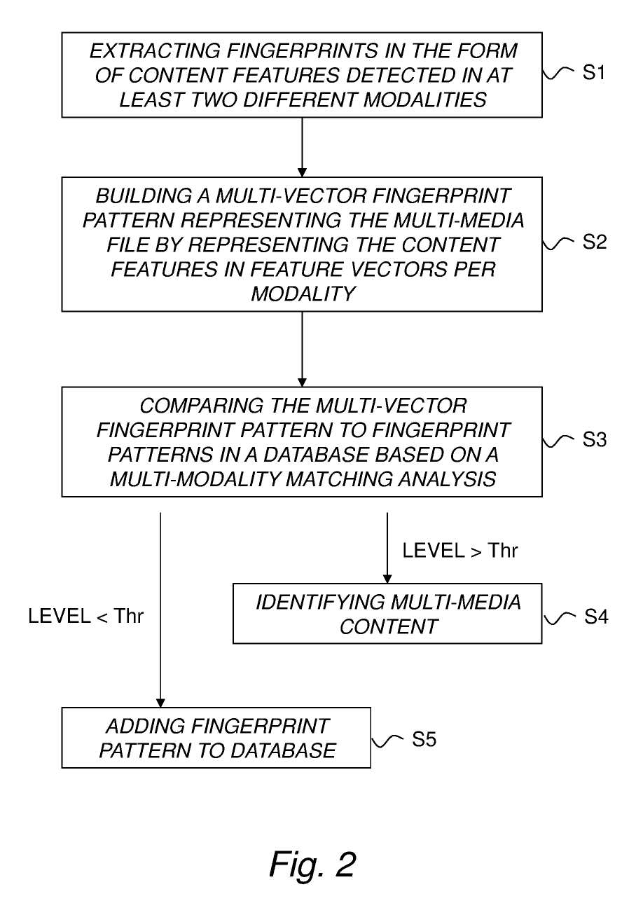

FIG. 2 is a schematic flow diagram illustrating another example of a method for fingerprinting and matching of content of a multi-media file according to an optional embodiment.

In an optional embodiment, the method further comprises the step S4 of identifying, if the level of similarity exceeds the threshold, Thr, the multi-media content corresponding to the fingerprint pattern(s) in the database for which the level of similarity exceeds the threshold.

In another optional embodiment, the method further comprises the step S5 of adding, if the level of similarity is lower than the threshold, Thr, the multi-vector fingerprint pattern to the database together with an associated content identifier.

In yet another optional embodiment, the at least two different modalities relate to different image and/or audio analysis processes for detecting content features including at least one of the following: text or character recognition, face recognition, speech recognition, object detection and color detection. This is a completely different approach compared to the conventional transform domain analysis of video segments.

As an example, considering modalities based on text recognition and face recognition, a first content feature may be a word or a set of words detected by text recognition such as Optical Character Recognition, OCR, and a second content feature may be a detected face represented, e.g. by a thumbnail of a face. By way of example, the first content feature may be a set of words such as “Joe is a great athlete”, as detected by text recognition, and the second content feature may be a visual representation of Joe's face. Although both the first and the second content feature may be associated with one and the same object, e.g. a person, each content feature is detected in a respective modality.

The detected content features may be organized in vectors or corresponding lists, at least one vector or list for each modality. For example, this means that one or more textual features such as words detected by text recognition may be stored in a first feature vector or so-called text feature vector, and representations of one or more face features such as detected faces may be stored, e.g. as thumbnails, in a second feature vector or so-called face feature vector. The lengths of the vectors may be different, i.e. the number of words in the text feature vector may differ from the number of face thumbnails in the face feature vector. The text feature vector, which may be seen as a list, and the face feature vector, which may be seen as a set of thumbnails representing different faces, builds up the multi-vector fingerprint pattern. In this case, the multi-vector fingerprint pattern includes two different vectors.

By way of example, the detected content features include at least textual features or voice features detected based on text recognition or speech recognition, respectively. This optional embodiment introduces new and customized modalities that enable fast and effective matching.

In an optional embodiment, the multi-modality matching process is a combined matching process involving at least two modalities, as exemplified below.

In another optional embodiment, the level of similarity is determined based on the number of matched content features over a period of time, per modality or for several modalities combined, or
the level of similarity is determined based on the number of consecutive matched content features over a period of time, per modality or for several modalities combined, or
the level of similarity is determined based on a ratio between the number of matched content features and the total number of detected content features over the same period of time, per modality or for several modalities combined.

Each modality may have its own specific threshold, or a so-called combined threshold that is valid for a combination of several modalities may be used.

When several modalities are combined, a faster and/or more robust matching may be achieved. For example, although no individual feature vector has still reached its own specific threshold, the level of similarity determined for several modalities combined may reach a combined threshold. This effectively means that the matching process may be completed more quickly, since when the combined threshold has been reached there is no need to continue collecting and analyzing more content features per individual vector or modality.

In this sense, the multi-modality matching process may be regarded as a combined matching process.

In yet another optional embodiment, the method for fingerprinting and matching of content is used for multi-media copy detection where a copy detection response is generated if the level of similarity exceeds the threshold, or for multi-media content discovery where a content discovery response is generated if the level of similarity exceeds the threshold. Optional examples of copy detection and content discovery will be described later on.

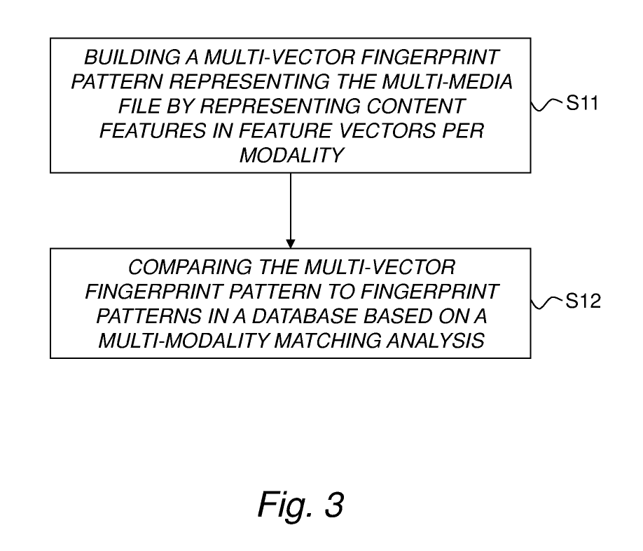

FIG. 3 is a schematic flow diagram illustrating an example of a method, performed by a server in a communication network, for fingerprinting and matching of content of a multi-media file according to an embodiment.

The method comprises the following steps of:

S11: building a multi-vector fingerprint pattern representing the multi-media file by representing content features, detected from at least a portion of the multi-media file in at least two different modalities, in at least one feature vector per modality, each content feature detected in a respective modality; and

S12: comparing the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

This provides an efficient server-solution for fingerprinting and matching of content of a multi-media file.

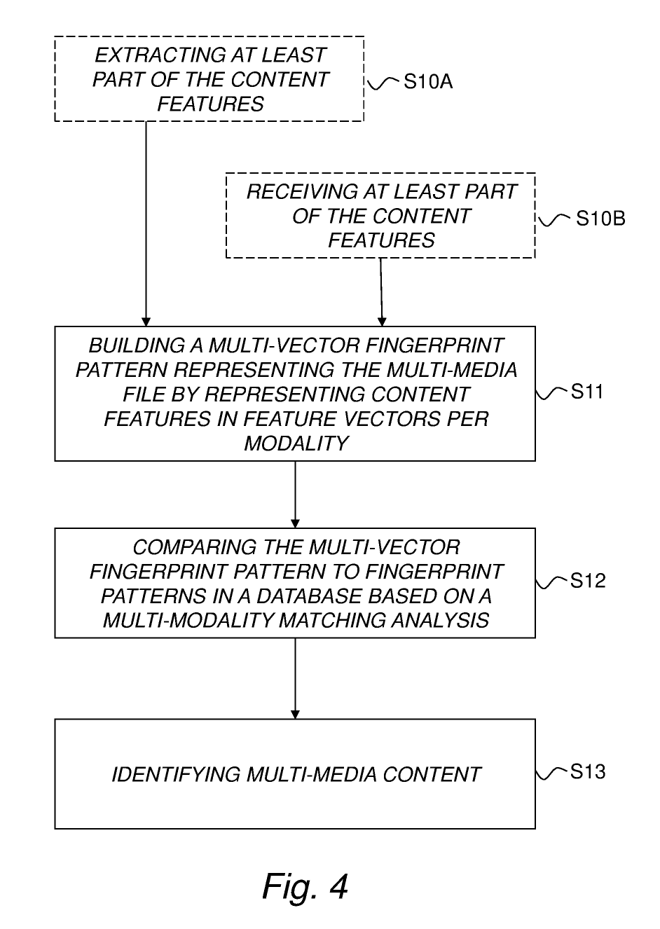

FIG. 4 is a schematic flow diagram illustrating another example of a method, performed by a server in a communication network, for fingerprinting and matching of content of a multi-media file according to an optional embodiment.

In an optional embodiment, the server extracts at least part of the content features as fingerprints from at least a portion of the multi-media file in optional step S10A, or the server receives at least part of the content features in optional step S10B.

In another optional embodiment, the server identifies, if the level of similarity exceeds the threshold, the multi-media content corresponding to the fingerprint pattern(s) in the database for which the level of similarity exceeds the threshold, in optional step S13.

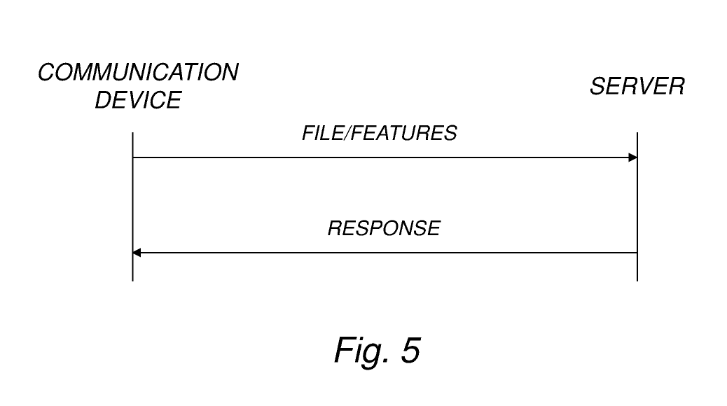

FIG. 5 is a schematic diagram illustrating an example of signaling between a communication device and a server in a communication network according to an optional embodiment. In an optional embodiment, the server receives, from a requesting communication device, the multi-media file or content features extracted therefrom, and identifies matching multi-media content, and sends a response including a notification associated with the matching multi-media content to the requesting communication device.

By way of example, the server(s) may be a remote server that can be accessed via one or more networks such as the Internet and/or other networks. The communication device may be any device capable of wired and/or wireless communication with other devices and/or network nodes of the network, including but not limited to User Equipment, UEs, and similar wireless devices, network terminals, embedded communication devices such as embedded telecommunication devices in vehicles, as will be exemplified later on.

The proposed technology also provides a computer program running on one or more processors of the communication device, e.g. a web browser running on a network terminal.

For example, the exchanged messages may be Hyper Text Transport Protocol, HTTP, messages. Alternatively, any proprietary communication protocol may be used.

As an example, the communication device may send a HTTP request and the server may respond with a HTTP response.

The proposed technology may be used in a wide variety of different applications, including copy detection and content discovery/search.

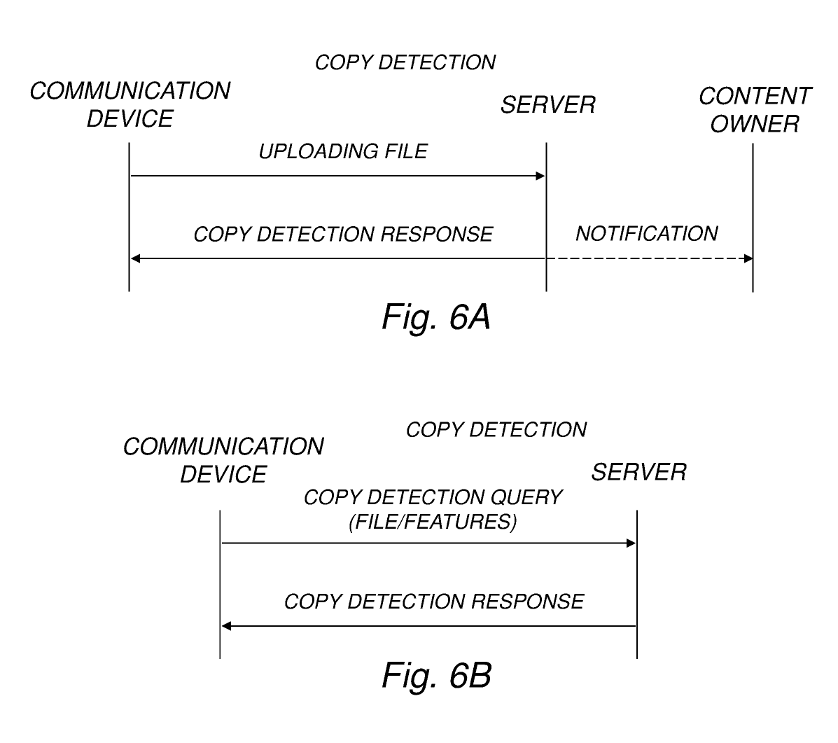

FIG. 6A is a schematic diagram illustrating an example of signaling involved in copy detection according to an optional embodiment. By way of example, the server, for multi-media copy detection, sends a copy detection response to the requesting communication device in connection with the communication device uploading the multi-media file to the server.

In an optional embodiment, the server may identify a content owner associated with matching multi-media content and send a notification to the content owner in response to multi-media copy detection.

FIG. 6B is a schematic diagram illustrating another example of signaling involved in copy detection according to an optional embodiment. According to an example, the server, for multi-media copy detection, receives a copy detection query from the requesting communication device, and sends a corresponding copy detection response to the requesting communication device.

By way of example, the copy detection query may include at least a subset of content features and/or the multi-media file or an indication of the location of the file. For example, the multi-media file itself or a Uniform Resource Locator, URL, to the multi-media file may be included in the copy detection query.

As an example, the copy detection query may be sent from the communication device side by the owner or a representative of the owner of the content or any other interested party.

For copy detection, different scenarios may be envisaged. By way of example, a service may be offered to the users assisting them when uploading their own content such as for example video files, see FIG. 6A. The server may then notify a communication device of a user that the video is already available under the restrictions the user had in mind, or add the file to the user's account or personal video library. In another case, concerning commercial content, content owners may be notified if someone else is uploading copyright protected content. In addition, the communication devices of users uploading copyright protected content may be notified, warned and/or prohibited to complete the upload of such files, see FIG. 6A.

It is also possible to provide a service where content owners or a representative of the owner actively investigates copy infringement by checking that no one has uploaded an illegal copy of copyright protected content, see FIG. 6B.

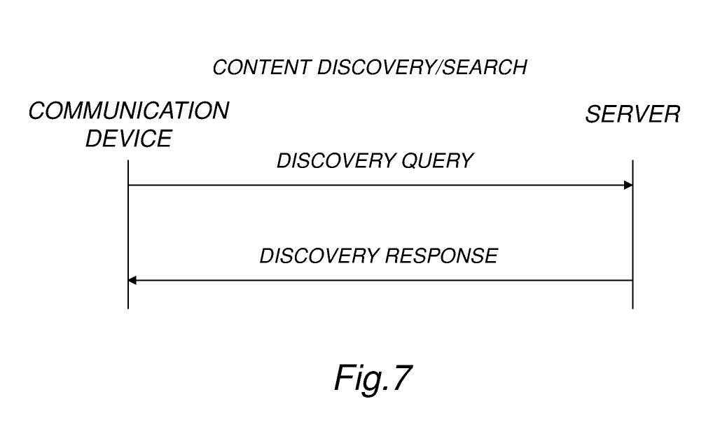

FIG. 7 is a schematic diagram illustrating an example of signaling involved in content discovery/search according to an optional embodiment. According to an example, the server, for multi-media content discovery, receives a content discovery query from the requesting communication device, and sends a corresponding content discovery response to the requesting communication device.

For content discovery, it is possible to provide a service where a video sequence is submitted and information about matching content is received. By way of example, the response may include various information about the original video such as where the original video was broadcasted or where the complete video or a version of better quality can be found.

In an optional embodiment, the at least two different modalities relate to different image and/or audio analysis processes for detecting content features including at least one of the following: text or character recognition, face recognition, speech recognition, object detection and color detection.

For example, to enable fast and effective matching, the detected content features may include at least textual features or voice features detected based on text recognition or speech recognition. Optical Character Recognition, OCR, is an example of a suitable technology for detecting textual features. By using speech recognition, spoken voice can be translated into textual features for effective matching. It has been noted that textual features are particularly useful for fast and effective matching.

Any suitable semantic(s) may be associated to the various modalities to allow a suitable semantic description of the detected feature. By way of example, when using face recognition, the “name” of an identified person may be associated with the detected face. Similarly, object recognition may also be associated with its own semantic, where a suitable descriptor or descriptive name is associated to a detected object. This also holds true for other modalities. Although two or more content features may be associated with the same object, each content feature such as a detected word or a detected face is generated by detection in a respective modality, e.g. using text recognition or face recognition, respectively.

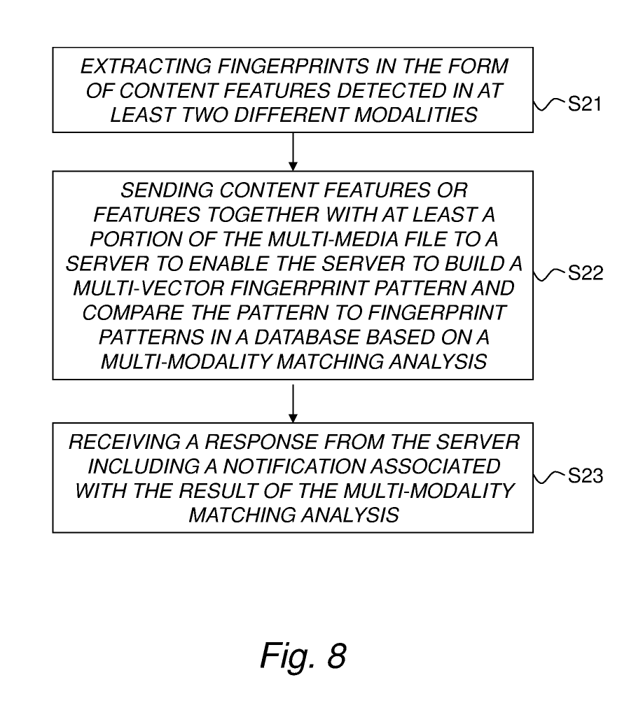

FIG. 8 is a schematic flow diagram illustrating an example of a method, performed by a communication device in a communication network, for enabling matching of content of a multi-media file according to an embodiment.

The method comprises the following steps of:

S21: extracting fingerprints from at least a portion of the multi-media file in the form of content features detected in at least two different modalities to provide a basis for at least part of a multi-vector fingerprint pattern in which content features are organized in at least one feature vector per modality, each content feature detected in a respective modality;

S22: sending the detected content features or the detected content features together with at least a portion of the multi-media file to a server to enable the server to build the multi-vector fingerprint pattern and compare the multi-vector fingerprint pattern to fingerprint patterns corresponding to known multi-media content, in a database based on a multi-modality matching analysis; and

S23: receiving a response from the server including a notification associated with the result of the multi-modality matching analysis performed by the server.

This provides a basis for at least part of a multi-vector fingerprint pattern and enables the server with which the communication device is cooperating to build a multi-vector fingerprint pattern that can be compared to fingerprint patterns in a database. In this way, the communication device provides useful support for efficient fingerprinting and matching.

Examples of different image and/or audio analysis processes for detecting content features include at least one of the following: text or character recognition, face recognition, speech recognition, object detection and color detection. As an example, it has been noted that textual features are particularly useful for fast and effective matching. In particular, it has been recognized that Optical Character Recognition, OCR, is an effective technique for the communication device to extract textual content features.

This means that the communication device may perform a partial analysis, which may then be complemented by a complementary analysis and extraction of fingerprints by the server.

In an optional embodiment, the communication device extracts fingerprints from at least a portion of the multi-media file in the form of content features detected in at least two different modalities, and sends these content features to the server.

In another optional embodiment, the response includes an identification of multi-media content corresponding to the fingerprint pattern(s) in the database for which the level of similarity compared to the multi-vector fingerprint pattern exceeds a threshold.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

Alternatively, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

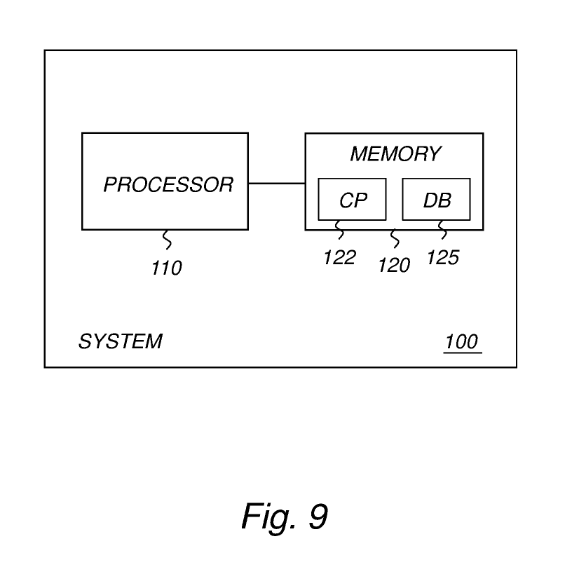

FIG. 9 is a schematic block diagram illustrating an example of a system configured to perform fingerprinting and matching of content of a multi-media file according to an embodiment.

The system is configured to extract fingerprints from at least a portion of the multi-media file in the form of content features detected in at least two different modalities, each content feature detected in a respective modality. The system is further configured to build a multi-vector fingerprint pattern representing the multi-media file by representing the content features in at least one feature vector per modality. The system is also configured to compare the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

In the particular example of FIG. 9, the system 100 comprises a processor 110 and a memory 120. The memory 120 comprises instructions executable by the processor 110, whereby the processor is operative to perform the fingerprinting and matching of content of the multi-media file. Normally, the instructions are arranged in a computer program, CP, 122 stored in the memory 120. The memory 120 may also include the database, DB, 125. Alternatively, the database 125 is implemented in another memory, which may or may not be remotely located, as long as the database is accessible by the processor 110.

In an optional embodiment, the system is configured to identify, if the level of similarity exceeds the threshold, the multi-media content corresponding to the fingerprint pattern(s) in the database for which the level of similarity exceeds the threshold.

In another optional embodiment, the system is configured to add, if the level of similarity is lower than the threshold, the multi-vector fingerprint pattern to the database together with an associated content identifier.

In yet another optional embodiment, the at least two different modalities relate to different image and/or audio analysis processes for detecting content features including at least one of the following: text or character recognition, face recognition, speech recognition, object detection and color detection.

By way of example, the system may be configured to extract fingerprints in the form of at least textual features or voice features detected based on text recognition or speech recognition.

In an optional embodiment, the system is configured to determine the level of similarity based on the number of matched content features over a period of time, per modality or for several modalities combined, or
the system is configured to determine the level of similarity based on the number of consecutive matched content features over a period of time, per modality or for several modalities combined, or
the system is configured to determine the level of similarity based on a ratio between the number of matched content features and the total number of detected content features over the same period of time, per modality or for several modalities combined.

In another optional embodiment, the system is configured to perform multi-media copy detection where a copy detection response is generated if the level of similarity exceeds the threshold or configured to perform multi-media content discovery where a content discovery response is generated if the level of similarity exceeds the threshold.

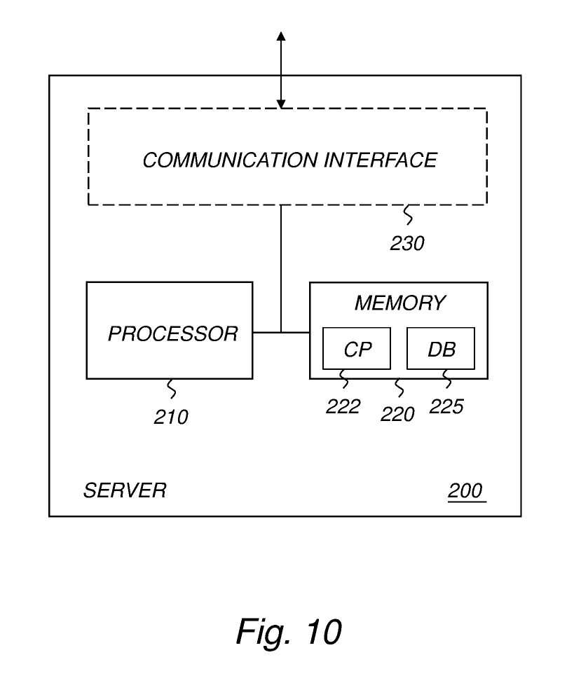

FIG. 10 is a schematic block diagram illustrating an example of a server configured to perform fingerprinting and matching of content of a multi-media file according to an embodiment.

The server is configured to build a multi-vector fingerprint pattern representing the multi-media file by representing content features, detected from at least a portion of the multi-media file in at least two different modalities, in at least one feature vector per modality, each content feature detected in a respective modality. The server is further configured to compare the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

As previously mentioned, the server(s) may be a remote server that can be accessed via one or more networks such as the Internet and/or other networks.

In the particular example of FIG. 10, the server 200 comprises a processor 210 and a memory 220. The memory 220 comprises instructions executable by the processor 210, whereby the processor is operative to perform the fingerprinting and matching of content of the multi-media file. Normally, the instructions are arranged in a computer program, CP, 222 stored in the memory 220. The memory 220 may also include the database, DB, 225. Alternatively, the database 225 is implemented in another memory, which may or may not be remotely located, as long as the database is accessible by the processor 210.

The server 200 may also include an optional communication interface 230. The communication interface 230 may include functions for wired and/or wireless communication with other devices and/or network nodes in the network. In a particular example, the communication interface 230 may even include radio circuitry for communication with one or more other nodes, including transmitting and/or receiving information. The communication interface 230 may be interconnected to the processor 210 and/or memory 220.

In an optional embodiment, the server is configured to extract at least part of the content features as fingerprints from at least a portion of the multi-media file, or the server is configured to receive at least part of the content features.

In another optional embodiment, the server is configured to identify, if the level of similarity exceeds the threshold, the multi-media content corresponding to the fingerprint pattern(s) in the database for which the level of similarity exceeds the threshold.

By way of example, the server may be configured to receive, from a requesting communication device, the multi-media file or content features extracted therefrom. The server may be configured to identify matching multi-media content, and configured to send a response including a notification associated with the matching multi-media content to the requesting communication device.

In an optional embodiment, the server, for multi-media copy detection, is configured to send a copy detection response to the requesting communication device in connection with the communication device uploading the multi-media file to the server.

In another optional embodiment, the server, for multi-media copy detection, is configured to receive a copy detection query from the requesting communication device, and configured to send a corresponding copy detection response to the requesting communication device.

In yet another optional embodiment, the server is configured to identify a content owner associated with matching multi-media content, and configured to send a notification to the content owner in response to multi-media copy detection.

According to another example, the server, for multi-media content discovery, may be configured to receive a content discovery query from the requesting communication device, and the server may be configured to send a corresponding content discovery response to the requesting communication device.

In an optional embodiment, the at least two different modalities relate to different image and/or audio analysis processes for detecting content features including at least one of the following: text or character recognition, face recognition, speech recognition, object detection and color detection.

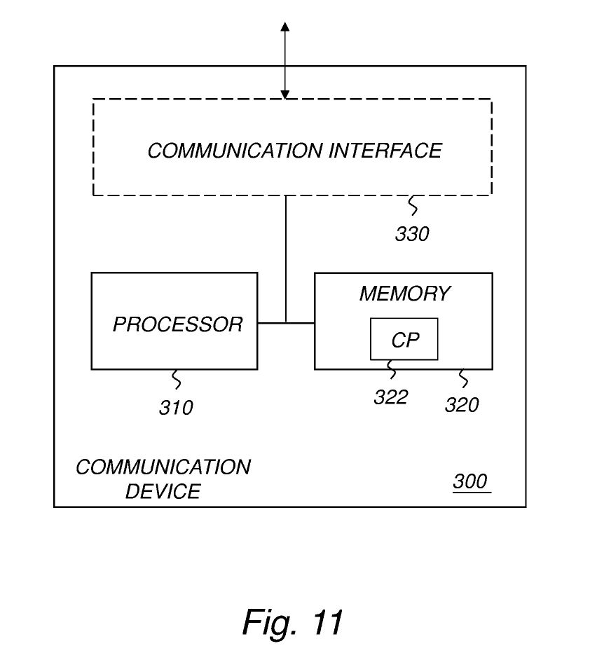

FIG. 11 is a schematic block diagram illustrating an example of a communication device configured to enable matching of content of a multi-media file according to an embodiment.

The communication device is configured to extract fingerprints from at least a portion of the multi-media file in the form of content features detected in at least two different modalities to provide a basis for at least part of a multi-vector fingerprint pattern in which content features are organized in at least one feature vector per modality, each content feature detected in a respective modality. The communication device is further configured to send the detected content features or the detected content features together with at least a portion of the multi-media file to a server to enable the server to build the multi-vector fingerprint pattern and compare the multi-vector fingerprint pattern to fingerprint patterns corresponding to known multi-media content, in a database based on a multi-modality matching analysis. The communication device is also configured to receive a response from the server including a notification associated with the result of the multi-modality matching analysis performed by the server.

In the particular example of FIG. 11, the communication device 300 comprises a processor 310 and a memory 320. The memory 320 comprises instructions executable by the processor 310, whereby the processor is operative to enable the matching of content of a multi-media file. Normally, the instructions are arranged in a computer program, CP, 322 stored in the memory 320.

The communication device 300 may also include an optional communication interface 330. The communication interface 330 may include functions for wired and/or wireless communication with other devices and/or network nodes in the network. In a particular example, the communication interface 330 may even include radio circuitry for communication with one or more other nodes, including transmitting and/or receiving information. The communication interface 330 may be interconnected to the processor 310 and/or memory 320.

In an optional embodiment, the communication device is configured to extract fingerprints from at least a portion of the multi-media file in the form of content features detected in at least two different modalities, and the communication device is configured to send the extracted content features to the server.

In another optional embodiment, the communication device is configured to receive a response from the server including an identification of multi-media content corresponding to the fingerprint pattern(s) in the database for which the level of similarity compared to the multi-vector fingerprint pattern exceeds a threshold.

In an optional embodiment, the communication device may be any device capable of wired and/or wireless communication with other devices and/or network nodes in the network, including but not limited to User Equipment, UEs, and similar wireless devices, network terminals, and embedded communication devices.

As used herein, the non-limiting terms “User Equipment” and “wireless device” may refer to a mobile phone, a cellular phone, a Personal Digital Assistant, PDA, equipped with radio communication capabilities, a smart phone, a laptop or Personal Computer, PC, equipped with an internal or external mobile broadband modem, a tablet PC with radio communication capabilities, a target device, a device to device UE, a machine type UE or UE capable of machine to machine communication, iPad, customer premises equipment, CPE, laptop embedded equipment, LEE, laptop mounted equipment, LME, USB dongle, a portable electronic radio communication device, a sensor device equipped with radio communication capabilities or the like.

In particular, the term “UE” and the term “wireless device” should be interpreted as non-limiting terms comprising any type of wireless device communicating with a radio network node in a cellular or mobile communication system or any device equipped with radio circuitry for wireless communication according to any relevant standard for communication within a cellular or mobile communication system.

As used herein, the term “wired device” may refer to any device configured or prepared for wired connection to a network or another device. In particular, the wired device may be at least some of the above devices, with or without radio communication capability, when configured for wired connection.

As indicated, at least some of the steps, functions, procedures, modules and/or blocks described herein may be implemented in a computer program, which is loaded into the memory for execution by processing circuitry including one or more processors. The processor(s) and memory are interconnected to each other to enable normal software execution. An optional input/output device may also be interconnected to the processor(s) and/or the memory to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

Accordingly, there is provided a computer program comprising instructions, which when executed by at least one processor, causes the at least one processor to:
build a multi-vector fingerprint pattern representing a multi-media file by representing content features, detected from at least a portion of the multi-media file in at least two different modalities, in at least one feature vector per modality, each content feature detected in a respective modality; and
compare the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

There is also provided a computer program comprising instructions, which when executed by at least one processor, cause the at least one processor to:
extract fingerprints from at least a portion of a multi-media file in the form of content features detected in at least two different modalities to provide a basis for at least part of a multi-vector fingerprint pattern in which content features are organized in at least one feature vector per modality, each content feature detected in a respective modality;
prepare the detected content features or the detected content features together with at least a portion of the multi-media file for transfer to a server to enable the server to build the multi-vector fingerprint pattern and compare the multi-vector fingerprint pattern to fingerprint patterns corresponding to known multi-media content, in a database based on a multi-modality matching analysis; and
read a response from the server including a notification associated with the result of the multi-modality matching analysis performed by the server.

The computer program(s) may be stored on a suitable computer-readable storage to provide a corresponding computer program product. By way of example, the software or computer program may be realized as a computer program product, which is normally carried or stored on a computer-readable medium, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

The flow diagram or diagrams presented herein may be regarded as a computer flow diagram or diagrams, when performed by one or more processors. A corresponding server and/or communication device may thus be defined as a group of function modules, where each step performed by the processor corresponds to a function module. In this case, the function modules are implemented as a computer program running on the processor. Hence, the server and/or communication device may alternatively be defined as a group of function modules, where the function modules are implemented as a computer program running on at least one processor.

The computer program residing in memory may thus be organized as appropriate function modules configured to perform, when executed by the processor, at least part of the steps and/or tasks described herein.

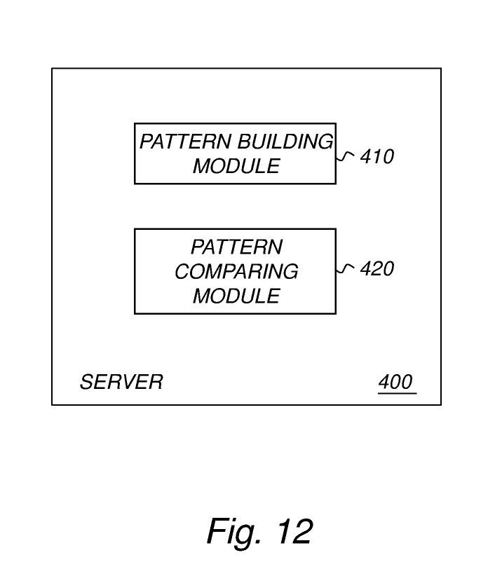

FIG. 12 is a schematic block diagram illustrating an example of a server for fingerprinting and matching of content of a multi-media file according to an embodiment.

The server 400 comprises:
a pattern building module 410 for building a multi-vector fingerprint pattern representing the multi-media file by representing content features, detected from at least a portion of the multi-media file in at least two different modalities, in at least one feature vector per modality, each content feature detected in a respective modality; and
a pattern comparing module 420 for comparing the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold.

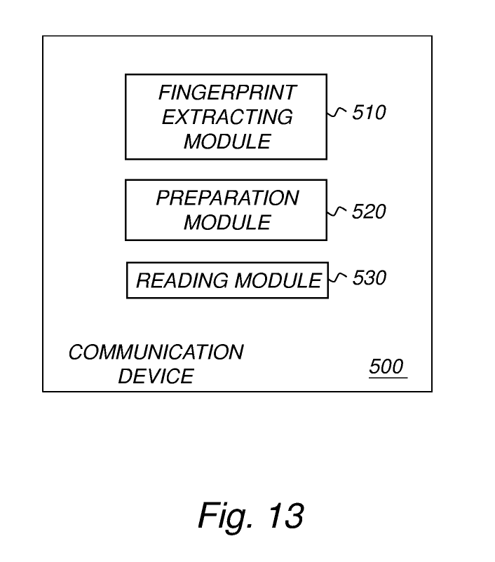

FIG. 13 is a schematic block diagram illustrating an example of a communication device for enabling matching of content of a multi-media file according to an embodiment.

The communication device 500 comprises:
a fingerprint extracting module 510 for extracting fingerprints from at least a portion of the multi-media file in the form of content features detected in at least two different modalities to provide a basis for at least part of a multi-vector fingerprint pattern in which content features are organized in at least one feature vector per modality, each content feature detected in a respective modality;
a preparation module 520 for preparing the detected content features or the detected content features together with at least a portion of the multi-media file for transfer to a server to enable the server to build the multi-vector fingerprint pattern and compare the multi-vector fingerprint pattern to fingerprint patterns corresponding to known multi-media content, in a database based on a multi-modality matching analysis; and
a reading module 530 for reading a response from the server including a notification associated with the result of the multi-modality matching analysis performed by the server.

In the following, complementary optional embodiments will be described to provide a more in-depth understanding of the proposed technology.

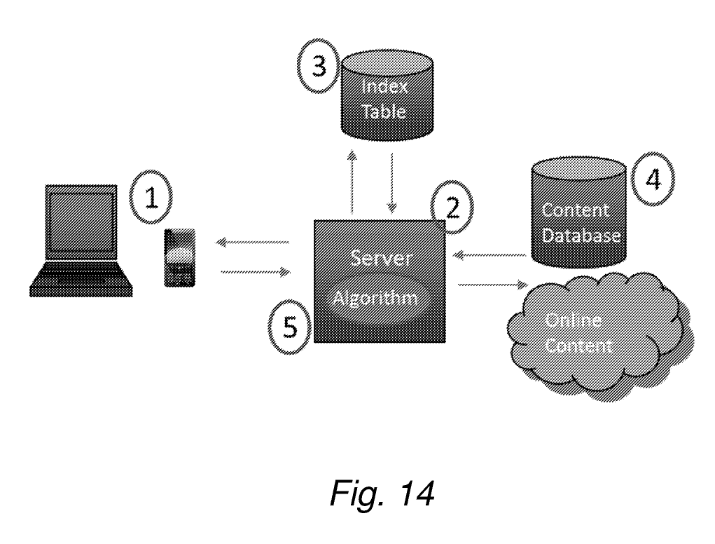

FIG. 14 is a schematic diagram illustrating an example of a system overview according to an optional embodiment.

The overall technology involves the following parts:
1. Client application. In this example, a client computer program is running on a processor, e.g. located in a communication device.
2. Server.
3. Fingerprint database, also referred to as an index table, or simply a database.
4. Content database.
5. Algorithm(s) for extraction, storing, matching of fingerprints.

Multi-media content such as video clips, whole videos and so forth that are uploaded or streamed via the server, which provides a service, will be analyzed and compared with the fingerprints stored in the database/index table.

The extraction algorithm may be used for creating unique fingerprints and fingerprint patterns for a certain video, which may be identified e.g. by video_id, URL, and the fingerprint pattern is stored separately in an index. The extraction can be done in advance for content owned by service provider(s) or during user-initiated upload or streaming via the service.

The proposed technology makes it possible to use indexed content for fast and effective video search and copy detection. The proposed technology may also provide efficient indexing, e.g. several video_id:s can be associated to same index.

For more information on extraction of fingerprints and multimedia content indexing, in general, reference can be made to [10, 11, and 12].

The matching algorithm compares extracted fingerprint(s) with fingerprints stored in the database/index table for the following non-limiting, optional purposes:
Add fingerprint data to the database/index table, e.g. for a new video file.
Video data search, similar to image or music search. Identify videos that the specific video clip originates from.
Copy detection.

In this optional embodiment, the proposed technology provides a system and algorithm(s) for automated extraction, indexing and matching of fingerprints and multi-vector fingerprint patterns for advanced multi-modal content detection.

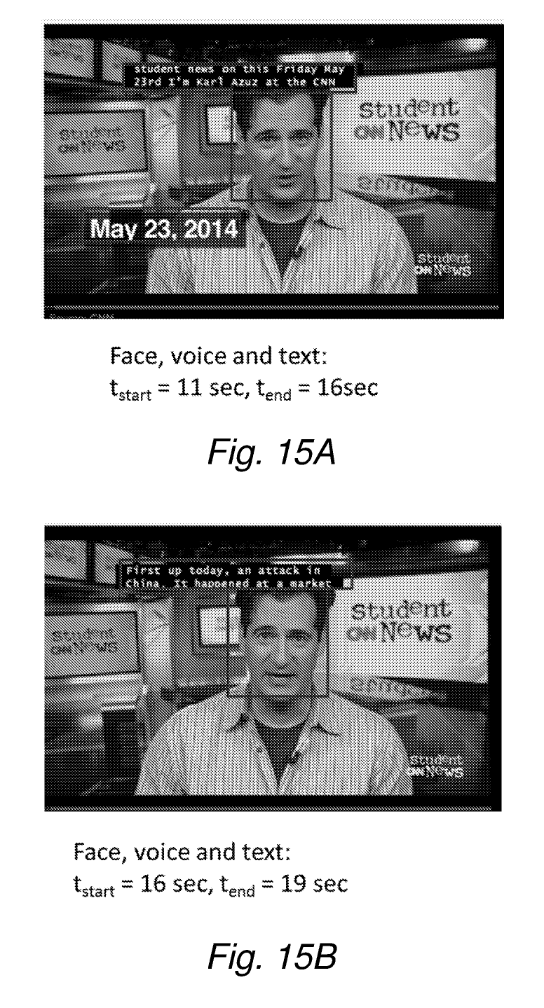

By way of example, the unique multi-vector fingerprint patterns of a single video includes a list of fingerprints for each modality, based on meta data extracted from small portions of the video, e.g. every frame or segments of 1-5 seconds. In FIG. 15A and FIG. 15B, sub-titles, speech and/or time stamps are identified using OCR, speech and/or face detection algorithms.

Each word or face that is detected will be extracted and stored in the database/index. For example, each content feature, sometimes simply referred to as a feature, will be associated with a modality and a start time and an end time. Fingerprints extracted from a video file can be described as a list of features, see example in the table below. If desired, each feature may be indexed and hyperlinked to a position in a particular video.

| MODALITY | tₛₜₐᵣₜ, t_{end} | Feature |
|---|---|---|
| OCR | 11, 16 | student news on this Friday May 23 |
| | | I'm Karl Azuz at CNN |
| OCR | 11, 16 | May 23, 2014 |
| Face | 11, 16 | Thumbnail 1 |
| Speech | 11, 16 | This is student news on this Friday |
| | | May 23 I'm Karl Azuz at CNN |
| | | Student News |
| OCR | 16, 19 | First up today an attack in China It |
| | | happened at a market |
| Face | 16, 19 | Thumbnail 2 |
| Speech | 16, 19 | First up today an attack in China It |
| | | happened at a market in North East |
| | | of China |

In this way, it is possible to build a multi-vector fingerprint pattern with content features represented in at least one feature vector per modality, each content feature detected in a respective modality.

In an optional embodiment, the system may continuously scan for new video files available online or stored in content database. As an example, the extraction of fingerprints may start as soon as a new file is detected.

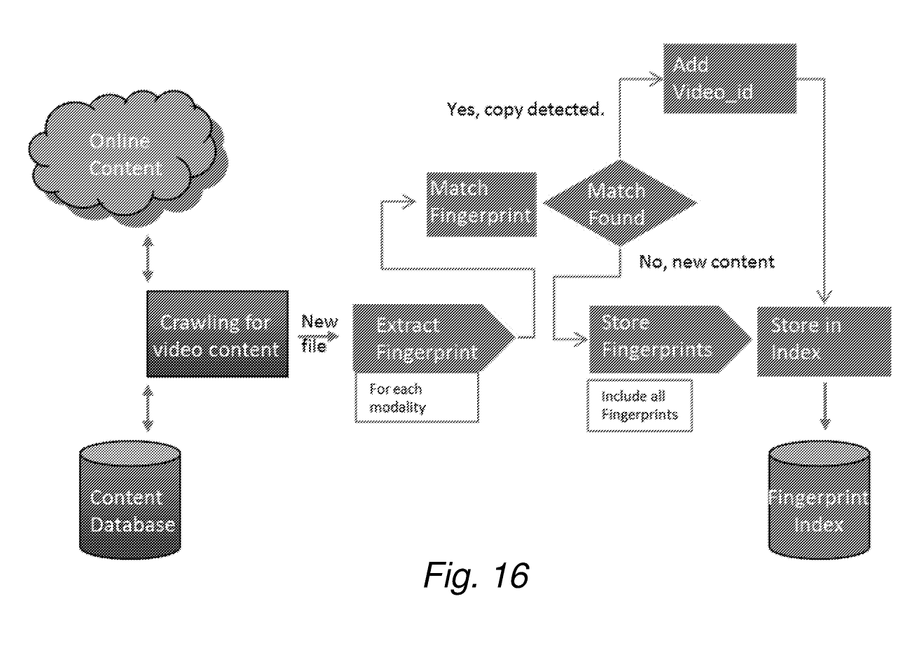

For example, with reference to FIG. 16, the fingerprints and fingerprint pattern for a specific video may be created in the following way:
The server continuously crawl content database and/or online content for new content.
Fingerprint analysis start as soon as a new video file is detected.
Extraction of fingerprints:
   Extract fingerprints (content features) for each modality and add time stamp for each fingerprint.
   Repeat for entire video file from time/frame zero to end of file, EOF, or a selected part of the video file.
   Repeat for the selected modalities.
Match Fingerprints (until EOF or Threshold)
   If there is a match
   Keep Video_id and associate to copy
   If no match
   Create multi-vector fingerprint pattern(s).
      Fingerprint pattern includes fingerprints related to each of the modalities.
   Add Fingerprints and Fingerprint pattern to database

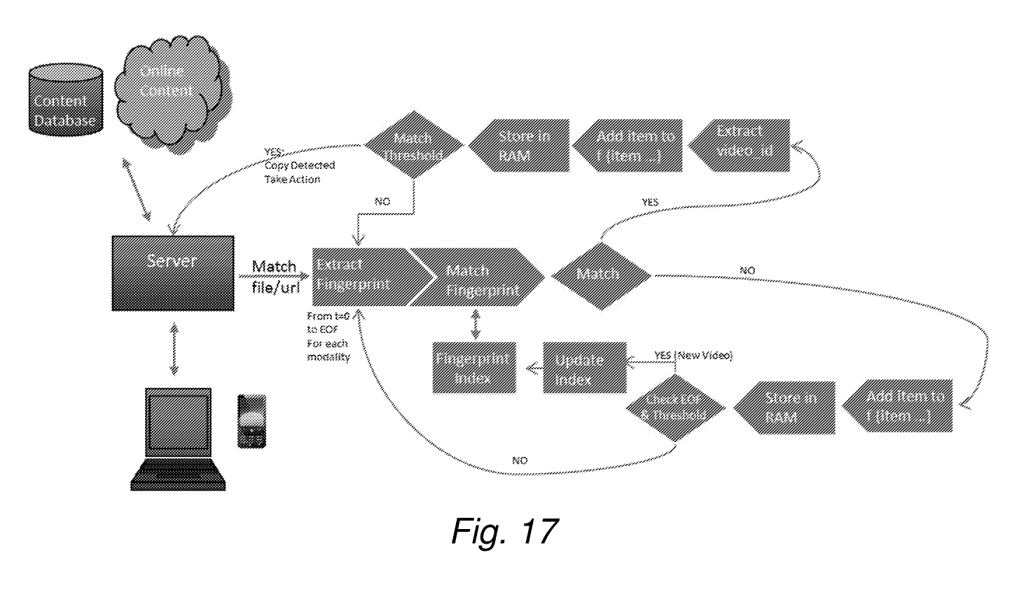

The non-limiting diagram of FIG. 17 below describes an example of the matching process and how fingerprints may be used for copy detection. The matching process will be initiated as soon as the client application stream (or download) content from the internet or from a content server.

In this example, each video is associated with a unique set of fingerprints and fingerprint patterns stored in the database/index.

The matching process results in either a match or a no match. No match means a new file and results in storing of the fingerprints into the fingerprint index. One or several matches between a video (streamed, uploaded or downloaded) via a server and fingerprints stored in the fingerprint index result in copy detection.

The match process generates one or several lists of content features, fingerprints, originating from one video and that are equal to fingerprints stored in the fingerprint index. This reflects that there is one or several matches between a streamed video and other videos indexed and stored in the content database.

As an example, a client application starts to upload, stream or download a video file, referred to as V1, from the internet or from a content server.

The server may initiate fingerprint extraction according to the following non-limiting example of pseudo code:

```
Extraction of fingerprints from V1
  For each modality (OCR, speech, face, song, sound etc)
    Extract fingerprints, f {features}, from t=0 (or frame=1) to EOF or
    until MATCH
      Match fingerprint, f {features}, with features in fingerprint index
      Match is detected
        Extract video_id for each Match
          For each video_id
            Add next item to fingerprint, f {feature₁..featureₙ}
            Calculate consecutive items
            Store in RAM
              Fingerprint {feature₁..featureₙ}, modality, tₛₜₐᵣₜ, t_{end},
              video_id
            If Sum Fingerprint {features} > threshold
                or Sum Fingerprint modalities {features} > threshold
                  or Match_ratio* > threshold
            then MATCH
              Copy Detected & Take Action
              else Extract fingerprints
      no Match
        Add next item to fingerprint, f {feature₁...featureₙ}
        Store in RAM
          Fingerprint {feature₁..featureₙ}, modality, tₛₜₐᵣₜ, t_{end}, V1
        If EOF & (Sum Fingerprint {features} < threshold
              or Sum Fingerprint modalities {features} < threshold or
                Match_ratio* < threshold)
            Update Fingerprint index for V1
            (Fingerprint {feature₁..featureₙ}, modality, tₛₜₐᵣₜ, t_{end}) for
            each modality
          else Extract fingerprints
```

As previously indicated, the fingerprinting system and algorithm(s) will also make it possible to search for videos using a picture, captured with e.g. a smart phone, screen shot or a short sequence of a video as a search query.

A client application, e.g. residing on a smart phone or a tablet-PC, can be used to capture an image from a TV or a video screen. The client application may be capable to:
Extract items from the image and submit these items to the server as a search query. The server will then match items with indexed data; or
Submit the captured image, and/or extracted content features, as a search query to the server. The server will start the matching process and extract and/or match content features from the image.

In both cases it will be possible to extract features representing two or more modalities, preferably OCR and Face, and match these items with the database/index.

In another example, a user may submit a short video clip, e.g. using the mobile phone to record an interesting clip on the TV or watching a short clip from the internet, to the server. The server initiates fingerprint extraction and matching to identify a match.

As previously discussed, the matching algorithm may use different thresholds and match ratios to identify a Match or a no Match. Thresholds and match ratios will make the matching process faster and more effective

For example, the following example thresholds may be used:
The number of consecutive features in a fingerprint match. The more consecutive matches the better match.
The threshold must be able to adjust depending different search scenario, e.g. a search query that contain a single image, a video clip or a full video.
The number of consecutive features for several modalities in a fingerprint match. The more consecutive matches the better match.
The threshold must be able to adjust depending different search scenario, e.g. a search query that contain a single image, a video clip or a full video.
Match ratio=The number of matched features for one or several modalities within a certain time frame divided by the total number of features within the same time frame.
Match ratio can be defined per modality.
Match ratio can be defined for all modalities.
Match ratio can be weighted based on modality to give a certain modality a higher relevance. Weighting modalities allows fine tuning of the fingerprint matching, where each modality can be seen as a separate filter.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

### REFERENCES

[1] Cisco Visual Networking Index: Global Mobile Data Traffic Forecast Update, 2013-2018, Cisco White Paper, Feb. 5, 2014.
[2] Cisco Visual Networking Index: Forecast and Methodology, 2012-2017, Cisco White Paper, May 29, 2013.
[3] YouTube: www.youtube.com, Internet citation retrieved on May 26, 2014.
[4] Shazam: www.shazam.com, Internet citation retrieved on May 26, 2014.
[5] EP 2 323 046.
[6] US 2009/154806.
[7] WO 2008/150544.
[8] WO 2009/106998.
[9] Content Based Copy Detection with Coarse Audio-Visual Fingerprints by Saracoglu et al. in Content-Based Multimedia Indexing, 2009, pp. 213-218.
[10] US 2014/0032538
[11] US 2014/0032562
[12] US 2013/0226930

1. A method for fingerprinting and matching of content of a multi-media file, the method comprising:
extracting fingerprints from at least a portion of the multi-media file in the form of content features detected in at least two different modalities, each content feature detected in a respective modality;
building a multi-vector fingerprint pattern representing the multi-media file by representing the content features in at least one feature vector per modality;
comparing the multi-vector fingerprint pattern to fingerprint patterns corresponding to known multi-media content, in a database based on a multi-modality matching analysis to determine whether the multi-vector fingerprint pattern has a level of similarity to any of the fingerprint patterns in the database that exceeds a threshold; and
adding, if the level of similarity is lower than the threshold, the multi-vector fingerprint pattern to the database together with an associated content identifier, wherein
the at least two different modalities relate to different image and/or audio analysis processes for detecting content features including at least one of the following: text recognition, character recognition, face recognition, speech recognition, object detection, and color detection.

2. The method of claim 1, further comprising the step of identifying, if the level of similarity exceeds the threshold, the multi-media content corresponding to the fingerprint pattern(s) in the database for which the level of similarity exceeds the threshold.

3-4. (canceled)

5. The method of claim 1, wherein the detected content features include at least textual features or voice features detected based on text recognition or speech recognition, respectively.

6. The method of claim 1, wherein the multi-modality matching process is a combined matching process involving at least two modalities.

7. The method of claim 1, wherein the level of similarity is determined based on at least one of:
the number of matched content features over a period of time, per modality or for several modalities combined,
the number of consecutive matched content features over a period of time, per modality or for several modalities combined, and
a ratio between the number of matched content features and the total number of detected content features over the same period of time, per modality or for several modalities combined.

8. The method of claim 1, wherein the method for fingerprinting and matching of content is used for multi-media copy detection where a copy detection response is generated if the level of similarity exceeds the threshold or for multi-media content discovery where a content discovery response is generated if the level of similarity exceeds the threshold.

9-20. (canceled)

21. A system configured to perform fingerprinting and matching of content of a multi-media file, wherein the system is configured to:
extract fingerprints from at least a portion of the multi-media file in the form of content features detected in at least two different modalities;
build a multi-vector fingerprint pattern representing the multi-media file by representing the content features in at least one feature vector per modality, each content feature detected in a respective modality;
compare the multi-vector fingerprint pattern to fingerprint patterns corresponding to known multi-media content, in a database based on a multi-modality matching analysis to identify whether the multi-vector fingerprint pattern has a level of similarity to any of the fingerprint patterns in the database that exceeds a threshold; and
add, if the level of similarity is lower than the threshold, the multi-vector fingerprint pattern to the database together with an associated content identifier, wherein
the at least two different modalities relate to different image and/or audio analysis processes for detecting content features including at least one of the following: text or character recognition, face recognition, speech recognition, object detection and color detection.

22. The system of claim 21, wherein the system is configured to identify, if the level of similarity exceeds the threshold, the multi-media content corresponding to the fingerprint pattern(s) in the database for which the level of similarity exceeds the threshold.

23-24. (canceled)

25. The system of claim 21, wherein the system is configured to extract fingerprints in the form of at least textual features or voice features detected based on text recognition or speech recognition.

26. The system of claim 21, wherein the system is configured to:
determine the level of similarity based on the number of matched content features over a period of time, per modality or for several modalities combined, or
determine the level of similarity based on the number of consecutive matched content features over a period of time, per modality or for several modalities combined, or
determine the level of similarity based on a ratio between the number of matched content features and the total number of detected content features over the same period of time, per modality or for several modalities combined.

27. The system of claim 21, wherein the system is configured to perform multi-media copy detection where a copy detection response is generated if the level of similarity exceeds the threshold or configured to perform multi-media content discovery where a content discovery response is generated if the level of similarity exceeds the threshold.

28-44. (canceled)

45. A computer program product comprising a non-transitory computer-readable medium storing a computer program comprising instructions for performing the method of claim 1.

46-47. (canceled)

48. A method for fingerprinting and matching of content of a multi-media file comprising a plurality of content features, the method comprising:
creating a first multi-vector fingerprint pattern for the multi-media file, wherein creating the first multi-vector fingerprint pattern for the multi-media file comprises:
using a first content feature detection process, detecting a first set of content features in the multi-media file;
forming a first feature vector comprising the first set of content features;
using a second content feature detection process detecting a second set of content features in the multi-media file;
forming a second feature vector comprising the second set of content features, wherein the first multi-vector fingerprint pattern comprises the first feature vector and the second feature vector;
obtaining from a database a second multi-vector fingerprint pattern, the second multi-vector fingerprint pattern being associated with a content identifier identifying a known multi-media file; and
comparing the first multi-vector fingerprint pattern with the second multi-vector fingerprint pattern to determine a similarity value representing a similarity between the first multi-vector fingerprint pattern and the second multi-vector fingerprint pattern.
